(19) United States
(12) Patent Application Publication
(10) Pub. No.: US 2006/0197340 A1
(43) Pub. Date: Sep. 7, 2006

(54) Flexible joint for exhaust pipe

(75) Inventor: Yoshiaki Senoo, Oda-gun (JP)

Correspondence Address: BURR & BROWN, PO BOX 7068, SYRACUSE, NY, 13261-7068, US

(73) Assignee: Katayama Kogyo Co., Ltd., Ibara-Shi (JP)

(21) Appl. No.: 11/071,061

(22) Filed: Mar. 3, 2005

(51) Int. Cl. F16L 51/02

(52) U.S. Cl. 285/226

(57) ABSTRACT

A flexible joint for an exhaust pipe includes: a bellows tube having a bellows portion; and an outer part disposed along an outer periphery of the bellows portion. One end portion of the bellows tube and one end portion of the outer part are connected together. An elastic ring is attached to the other end portion of the outer part. A stopper is provided on the other end portion of the bellows tube. When deformation of the bellows portion in at least one of compression direction and expansion direction exceeds a predetermined amount, the elastic ring engages with the stopper to regulate the deformation of the bellows portion.

### BACKGROUND OF THE INVENTION

The present invention relates to a flexible joint that is used to absorb vibration of an exhaust pipe of an automobile.

An exhaust pipe is attached to the exhaust system of the internal combustion engine of an automobile, and a flexible joint that uses a bellows tube connected to that exhaust pipe is employed to absorb vibrations such as those of the internal combustion engine or those induced by the running of the automobile.

This bellows portion is required to absorb large quantities of vibration and have superb durability.

There is therefore a tendency to increase the overall length because of reasons such as the advantages of having a large number of corrugations in the bellows portion, but this increase in length not only limits the layout of the exhaust system, it is also one cause of an increase in cost.

Recent strengthening of regulations concerning exhaust gas emission standards has made it necessary to attach devices such as exhaust gas scrubbers, which is making it more difficult to ensure enough space for installing the various components of the exhaust system in the automobile.

In such a case, the flexible joint is also required to be even more compact, in order to save space.

The present inventor has already proposed a technique for a flexible joint (bellows joint) that is intended to improve the durability of the bellows portion by reducing the weight acting on the bellows portion, and shorten the length of the bellows portion (see Japanese Patent Laid-Open No. 2857354).

The above-mentioned invention was designed to reduce the weight acting on the bellows portion, but the objective of the present invention is to ensure the durability of the flexible joint by regulating the amount of deformation with respect to vibrational input so that vibrations are absorbed gently within a predetermined range, but the amount of deformation is regulated with respect to excessive vibrational input.

### BRIEF SUMMARY OF THE INVENTION

A first aspect of the present invention relates to a flexible joint for an exhaust pipe, the flexible joint including:

a bellows tube having a bellows portion; and

an outer part disposed along an outer periphery of the bellows portion,

wherein one end portion of the bellows tube and one end portion of the outer part are connected together,

wherein an elastic ring is attached to the other end portion of the outer part,

wherein a stopper is provided on the other end portion of the bellows tube, and

wherein when deformation of the bellows portion in at least one of compression direction and expansion direction exceeds a predetermined amount, the elastic ring engages with the stopper to regulate the deformation of the bellows portion.

A second aspect of the present invention relates to a flexible joint for an exhaust pipe, the flexible joint including:

a bellows tube having a bellows portion; and

at least two outer parts which are connect to two end portions of the bellows tube, respectively, and disposed facing each other along an outer periphery of the bellows portion,

wherein an elastic ring is held mutually by an elastic ring holder portion of each of the outer parts, the elastic ring holder portion being provided at an end portion of each of the outer parts facing each other.

### BRIEF DESCRIPTION OF THE SEVERAL VIEWS OF THE DRAWING

FIG. 1 shows an example of a flexible joint in accordance with the present invention;

FIG. 2 shows an example in which hook-shaped elastic ring holder portions are formed on the outer parts to provide a stopper function;

FIG. 3 shows an example of a shock-absorbing member on the elastic ring;

FIG. 4 shows an example of a shock-absorbing member on a stopper;

FIG. 5 shows an example that is provided with circular cylindrical elastic ring holder portions on the outer parts;

FIG. 6 shows the clearances of the elastic ring;

FIGS. 7A and 7B show connections of the elastic ring; and

FIGS. 8A to 8C are illustrative of the actions with respect to bellows vibration.

### DETAILED DESCRIPTION OF THE EMBODIMENTS

The present invention may provide a flexible joint for an exhaust pipe of an automobile that enables a higher level of vibration absorption and a superior durability in a flexible joint formed of a bellows tube, even when the length of the bellows portion is shortened.

A flexible joint according to one embodiment of the present invention includes:

a bellows tube having a bellows portion; and

an outer part disposed along an outer periphery of the bellows portion,

wherein one end portion of the bellows tube and one end portion of the outer part are connected together,

wherein an elastic ring is attached to the other end portion of the outer part,

wherein a stopper is provided on the other end portion of the bellows tube, and

wherein when deformation of the bellows portion in at least one of compression direction and expansion direction exceeds a predetermined amount, the elastic ring engages with the stopper to regulate the deformation of the bellows portion.

In this manner, one end portion of the bellows portion and one end portion of the outer part are connected together, but the other end portion of the bellows portion and the other end portion of the outer part are in a mutually free state, so that the bellows portion can deform freely in answer to expansion/compression vibrations within the predetermined range, thus absorbing vibrational energy gently.

When the bellows portion is subjected to expansion/compression vibrations that exceed the amount of deformation of the predetermined range, the elastic ring attached to the free end portion of the outer part comes into contact with the stopper while deforming.

Thus vibrational energy is absorbed by the amount of flexure of the elastic ring and also excessive deformation applied to the bellows portion can be regulated by this elastic ring.

In this case, the elastic ring is formed by using an elastic member that has flexure, such as a wire, in an annular form.

The elastic ring may be formed by connecting two ends of a flexible wire with a crimping member.

In addition, the stoppers that regulate the deformation of the elastic ring may not correspond to the entire periphery of the elastic ring but may correspond to only part thereof to generate flexible deformation of the elastic ring.

If these stoppers regulate only part of the elastic ring, providing some slack in the elastic ring makes it possible to widely adjust the degree of freedom of deformation of the bellows portion by the magnitude of that slack.

It is therefore possible to adjust the amount of free deformation of the bellows portion by the amount of slack of the elastic ring.

A shock-absorbing member may be attached to at least one of the elastic ring and the stopper.

This makes it possible to reduce contact noise between this elastic ring and the stoppers.

In addition, if the shock-absorbing member is attached not to the entire surface around the periphery of the elastic ring but only partially, a shock-absorbing action can be imparted and flexible deformation can be generated in the elastic ring.

If the configuration is to be such that a fixed free expansion/compression range is set for the bellows portion and deformation is generated for any excess deformation in the compression or expansion direction, a method of providing at least two outer parts linked mutually through the elastic ring instead of the above-described stoppers could be used as the method of regulating such motions.

A flexible joint according to another embodiment of the present invention includes:

a bellows tube having a bellows portion; and

at least two outer parts which are connect to two end portions of the bellows tube, respectively, and disposed facing each other along an outer periphery of the bellows portion,

wherein an elastic ring is held mutually by an elastic ring holder portion of each of the outer parts, the elastic ring holder portion being provided at an end portion of each of the outer parts facing each other.

In that case, the deformation of the bellows portion can be adjusted by the amount of flexure of the elastic ring held between the two outer parts. In this case, a predetermined gap may be provided between the elastic ring and the elastic ring holder portion. Adjustment of this gap adjusts the amount of free deformation of the bellows portion.

The elastic ring may be provided with slack. This enables adjustment of the amount of free deformation by this amount of slack.

A shock-absorbing member may be attached to at least one of the elastic ring and the elastic ring holder portion.

The elastic ring may be wound at least one turn around the outer periphery of the bellows portion.

If the elastic ring is wound at least one complete turn, vibrational energy is absorbed even when the bellows tube is loaded by bending stresses from any direction around the full 360 degrees thereof.

The elastic ring may be formed by connecting two ends of a flexible wire with a crimping member.

Since the present invention ensures that a predetermined clearance is provided between the elastic ring (made of wire of the like, to regulate the amount of deformation of the bellows portion) and each stopper, vibrations can be gently absorbed by the flexure of the bellows portion for deformations within the predetermined range, reducing irritations such as noise, vibration, and harshness (NVH) and making the automobile more comfortable to travel in.

If the bellows portion is subjected to a deformation that is greater than the predetermined amount, the elastic ring made of wire or the like strikes a stopper and flexes, so that the elastic ring acts as a damper to apply a regulatory force that gradually increases, absorbing the vibrational energy.

A similar effect can be obtained by extending the outer part from both end portions of the bellows tube and holding the elastic ring therebetween by holder portions, instead of providing stoppers.

In that case, the free vibration range of the bellows portion can be adjusted freely by the gap between the elastic ring and the holder portions or the amount of slack in the elastic ring.

In this manner, the response of the elastic ring with respect to excessive force is regulated by the stoppers or the mutual action of the outer parts, so that such forces are not transferred to the bellows portion, thus ensuring the durability of the bellows portion.

Since the bellows portion does not need to absorb excessive forces, the number of corrugations of the bellows portion can be reduced and, as a result, the overall length thereof can be reduced.

This makes it possible to design a more compact flexible joint, reducing limitations on layout when mounting the assembly in an automobile.

The insertion of a shock-absorbing member made of mesh or the like between the elastic ring made of wire or the like and each stopper or holder portion of the outer parts makes it possible to reduce contact noise.

Embodiments of the present invention are described below with reference to the accompanying figures.

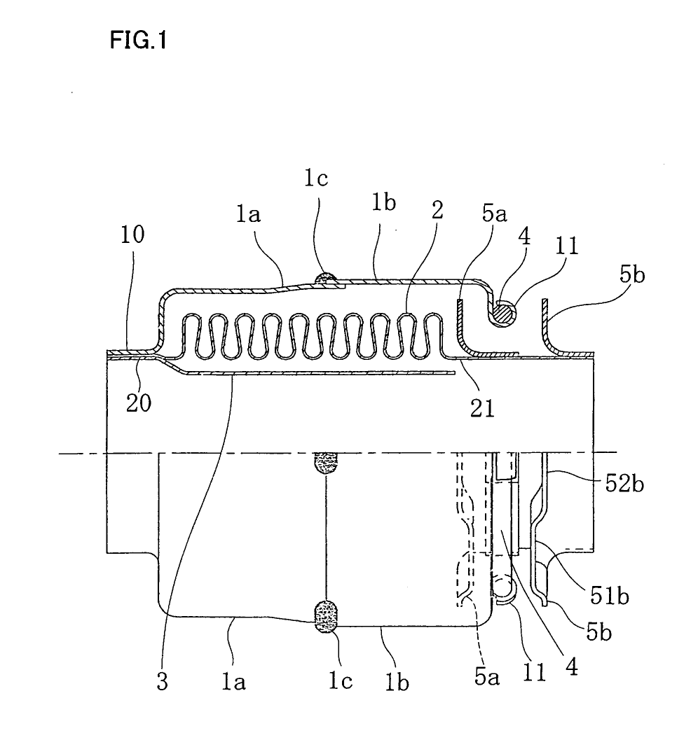

A partial section through the side surface of a flexible joint in accordance with an embodiment of the invention is shown in FIG. 1.

Outer parts (1a and 1b) are provided in the vicinity of outer peripheries of a bellows tube 2, and an end portion 20 at one end of a bellows portion and an end portion 10 at one end of the outer parts are connected together.

An elastic ring 4 is attached to another end portion 11 of the outer part, in a state that is mutually free from a further end portion 21 of the bellows portion.

In the example shown in FIG. 1, the outer parts 1a and 1b are formed separately and are connected by means such as welding (1c), but that is solely for reasons of ease of manufacture and it is not absolutely necessary to divide the members in this manner.

The elastic ring 4 is formed of a flexible material such as wire and is partially connected to the end portion 11 of the outer part 1b.

A stopper 5b and a stopper 5a are disposed at predetermined distances from this elastic ring. The stopper 5b regulates the deformation of the elastic ring if the bellows portion is subjected to more than a predetermined amount of compression deformation, and the stopper 5a regulates the deformation of the elastic ring if the bellows portion is subjected to more than a predetermined amount of expansion deformation.

Taking the stopper 5b by way of example, a protrusion 51b and a depression 52b are provided in the surface that comes into contact with the elastic ring, and this elastic ring is attached to the end portion 11 of the outer part in such a manner that the protrusion 51b and the elastic ring 4 come into contact.

Thus the bellows portion freely and gently absorbs vibrations within the gap between the elastic ring 4 and each stopper (5a or 5b). However, if the deformation in the compression or expansion direction exceeds that amount, the elastic ring comes into contact with the protrusion of the corresponding stopper, which creates flexure in the elastic ring to absorb vibrations and also acts to ensure that the bellows portion is not displaced more than a fixed amount.

Note that an inner member 3 is disposed on the inner side of the bellows tube, to align the flow of exhaust gases and prevent the generation of unpleasant noise due to turbulence of the exhaust gases in the bellows portion.

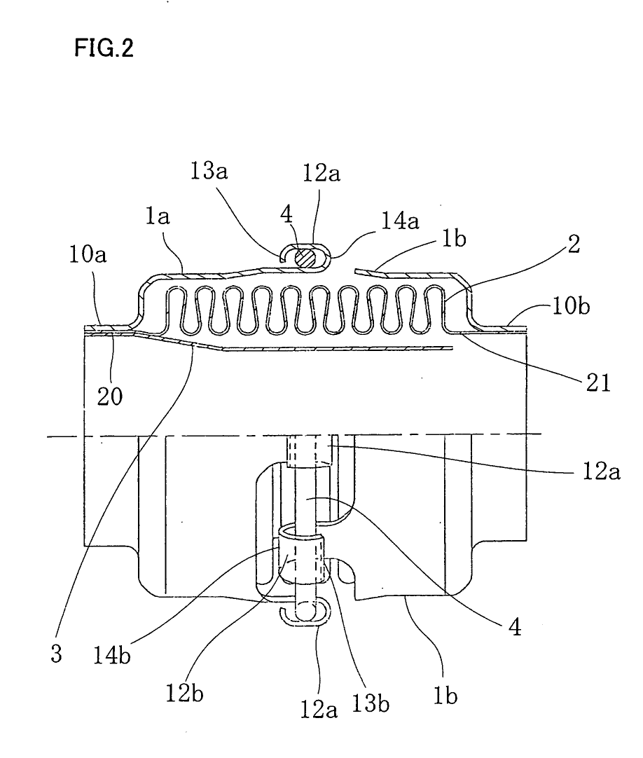

In an embodying example shown in FIG. 2, the outer part is divided into members 1a and 1b, one end (10a or 10b) of each outer part is connected to the corresponding end portion 20 or 21 of the bellows portion, and holder portions for the elastic ring are provided at other, free end portions 12a and 12b of the outer parts 1a and 1b in such a manner as to form hooks that engage alternately from either side of the elastic ring 4.

Bent portions (13a are 14a) is formed on each hook portion 12a to act as stoppers 13a and 14a for the elastic ring 4 when a compression deformation or of expansion deformation that is greater than the predetermined amount is applied to the bellows portion.

Similarly, bent portions 13b and 14b are provided on the hook portion 12b to act as stoppers 13b and 14b, in the opposite direction to those on the hook portion 12a.

In this case, the outer part is endowed with a stopper function such that deformation between the bent portions 13a and 14a absorbs the vibrational energy only for expansion/compression deformation of the bellows portion, by way of example. For loadings of compressive forces in excess of that amount, the flexure of the elastic ring is utilized by the alternate jostling from both sides of the bent portions (stoppers) 13a and 13b of the hook portions 12a and 12b, to absorb the vibrational energy.

If an expansive force that is greater than the predetermined amount is applied to the bellows portion, on the other hand, the flexure of the elastic ring 4 is utilized by the alternate pulling from both sides of the bent portions (stoppers) 14a and 14b, to prevent excessive deformation of the bellows portion.

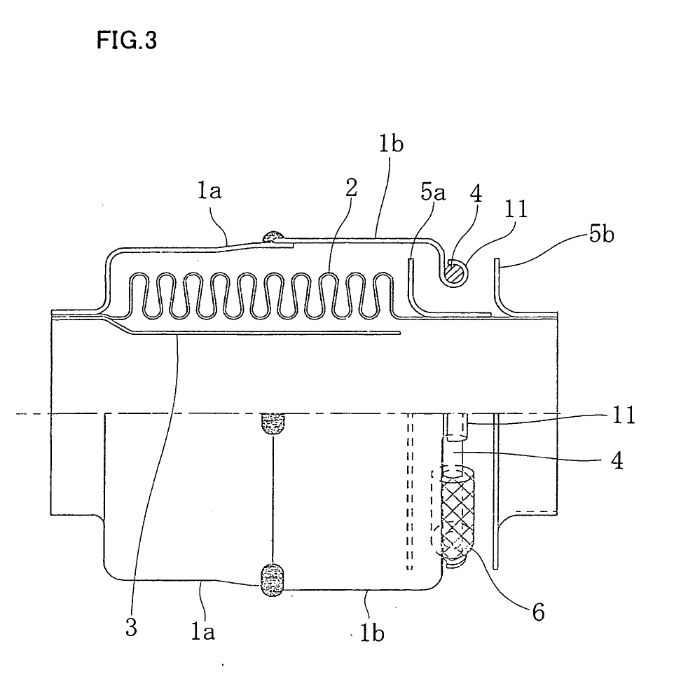

An example of the attachment of a shock-absorbing member 6 such as a mesh member to the elastic ring 4 is shown in FIG. 3.

In this case, contact noise is reduced by the interposition of the shock-absorbing member 6 between the elastic ring 4 and the stoppers 5a and 5b, to absorb contacts therebetween.

In addition, the elastic ring could be given some flexure by attaching the shock-absorbing member partially to the elastic ring, without having to form depressions and protrusions on the striking surfaces of the stoppers.

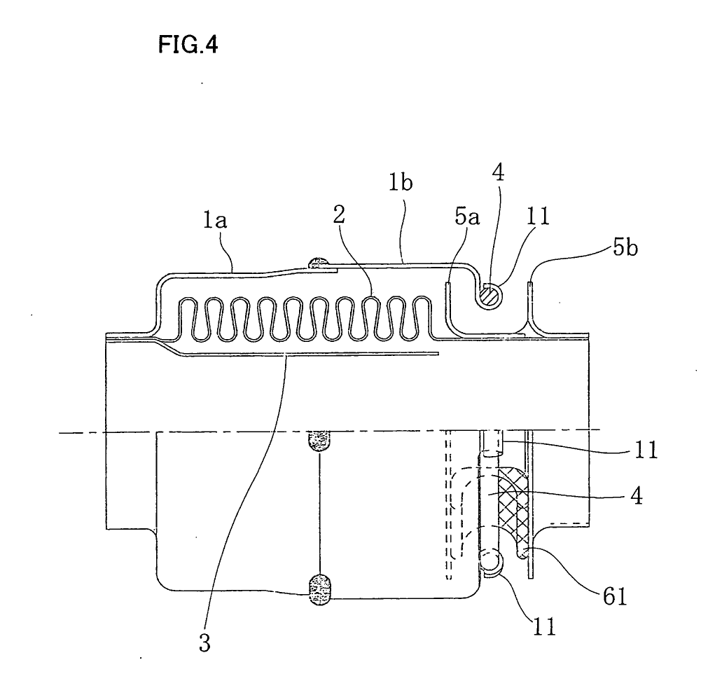

An example of the attachment of a shock-absorbing member 61 to the stoppers 5a and 5b is shown in FIG. 4, where the action thereof is similar to that of the configuration of FIG. 3 so further description thereof is omitted.

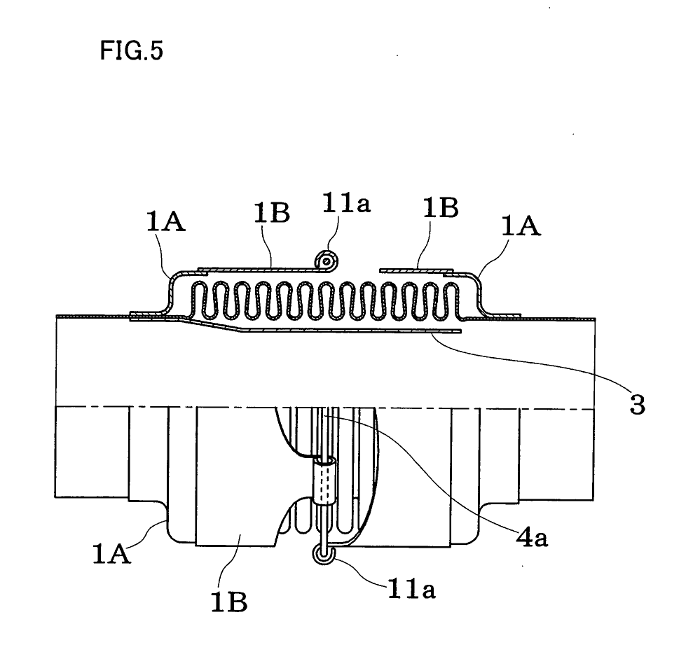

In a configuration shown FIG. 5, the hook shapes of the outer parts of FIG. 2 are further expanded into a circular cylindrical form, facilitating the holding of the elastic ring and also making it easy to adjust the amount of sag thereof.

An outer part 1A is provided to extend from the end portion at each side of the bellows tube, and an outer part 1B is connected to the tip of each outer part 1A by means such as welding.

The outer parts 1A and 1B could be formed integrally, but manufacturing the outer parts 1A and 1B separately makes it possible to form the outer part 1B to match the length of the bellows portion and thus enable the manufacture of a series of related components.

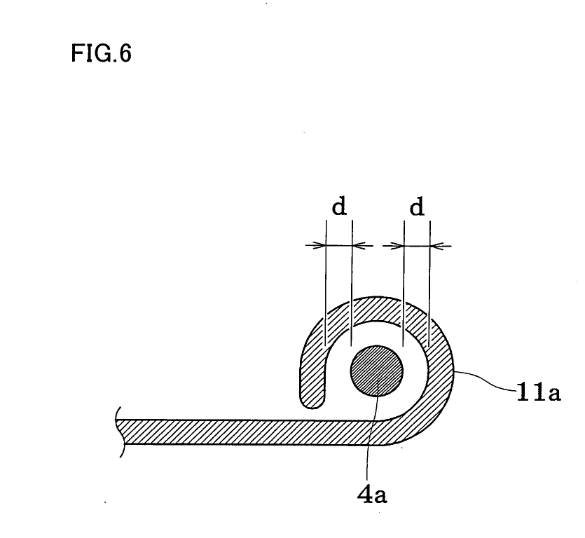

Holder portions 11a are formed at free end portions extending outward from each end portion of the bellows tube, to mutually hold an elastic ring 4a and also form a predetermined gap (clearance) d between the elastic ring 4a and each holder portion 11a, as shown in FIG. 6. This provides a stopper function with respect to vibrational deformation of the bellows portion.

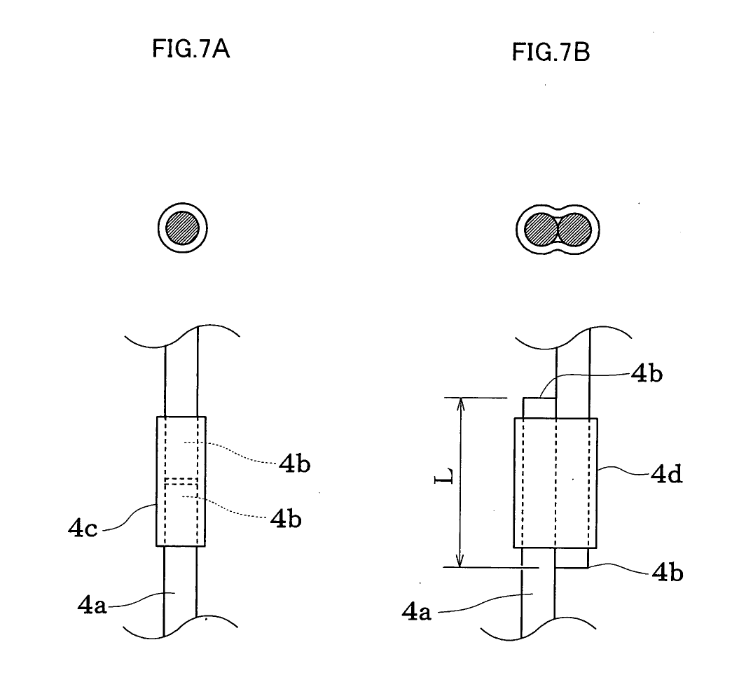

Two methods could be used as means of linking in the peripheral direction of the elastic ring 4a. In one, both end portions 4b of the elastic ring are held close together and are connected by a crimping member 4c, as shown in FIG. 7A. In the second method, the two end portions are overlaid and are connected by a crimping member 4d, as shown in FIG. 7B.

If the peripheral length of the elastic ring is set to generate some slack in the peripheral direction of the elastic ring, the amount of deformation of the bellows portion corresponding to the gap d shown in FIG. 6 and the amount of slack of the elastic ring can be set to the free vibration amplitude.

Thus the free vibration amplitude can be set freely by adjusting the length of the overlap L shown in FIG. 7B.

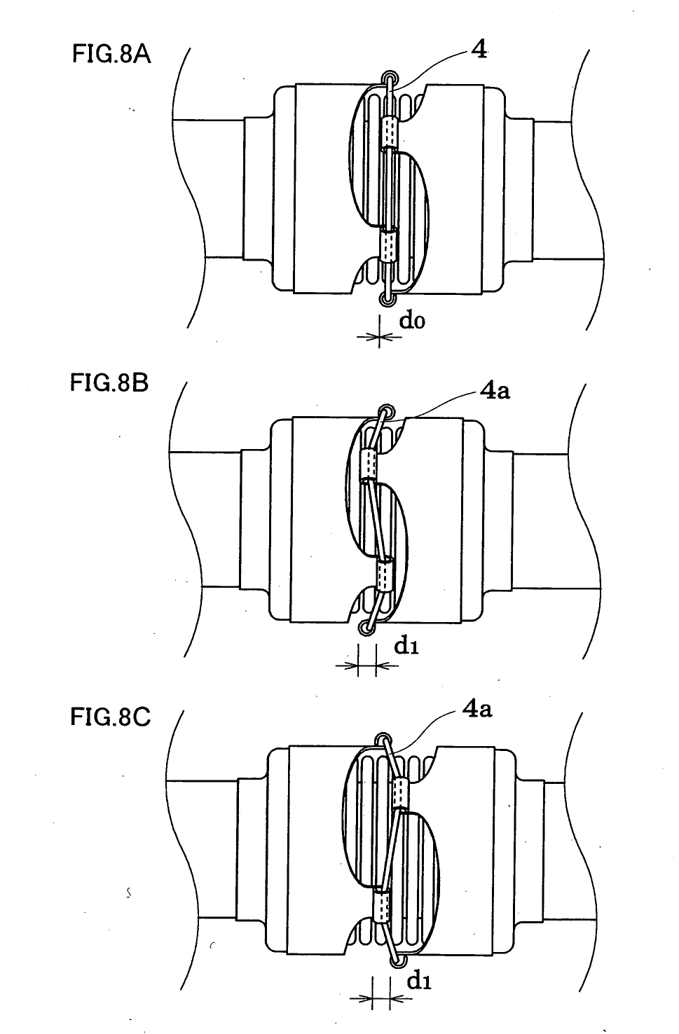

This effect is described below, with reference to FIG. 8.

As shown in FIG. 8A, if there is no slack d0 in the peripheral length of the elastic ring 4, the free vibration amplitude of the bellows portion is just the amount of the clearance (d+d) shown in FIG. 6, and thus any further deformation in the length of the bellows portion regulates vibration by the elastic force of the elastic ring.

In contrast thereto, if there is some slack in the peripheral length of the elastic ring, as shown in FIGS. 8B and 8C, the amount of free deformation amplitude d1 due to that slack acts as free vibration in both the compression direction (FIG. 8B) and the expansion direction (FIG. 8C), making it simple to adjust the free vibration amplitude.

In addition, a shock-absorbing member could be provided on at least one of the elastic ring and the elastic ring holder portions of the outer part.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A flexible joint for an exhaust pipe, the flexible joint comprising:
a bellows tube having a bellows portion; and
an outer part disposed along an outer periphery of the bellows portion,
wherein one end portion of the bellows tube and one end portion of the outer part are connected together,
wherein an elastic ring is attached to the other end portion of the outer part,
wherein a stopper is provided on the other end portion of the bellows tube, and
wherein when deformation of the bellows portion in at least one of compression direction and expansion direction exceeds a predetermined amount, the elastic ring engages with the stopper to regulate the deformation of the bellows portion.

2. The flexible pipe for an exhaust pipe as defined by claim 1, wherein the elastic ring is provided with slack.

3. The flexible pipe for an exhaust pipe as defined by claim 1, wherein the elastic ring is wound at least one turn around the outer periphery of the bellows portion.

4. The flexible pipe for an exhaust pipe as defined by claim 1, wherein the elastic ring is formed by connecting two ends of a flexible wire with a crimping member.

5. The flexible pipe for an exhaust pipe as defined by claim 1, wherein a shock-absorbing member is attached to at least one of the elastic ring and the stopper.

6. A flexible joint for an exhaust pipe, the flexible joint comprising:
a bellows tube having a bellows portion; and
at least two outer parts which are connect to two end portions of the bellows tube, respectively, and disposed facing each other along an outer periphery of the bellows portion,
wherein an elastic ring is held mutually by an elastic ring holder portion of each of the outer parts, the elastic ring holder portion being provided at an end portion of each of the outer parts facing each other.

7. The flexible pipe for an exhaust pipe as defined by claim 6,
wherein a predetermined gap is provided between the elastic ring and the elastic ring holder portion.

8. The flexible pipe for an exhaust pipe as defined by claim 6, wherein the elastic ring is provided with slack.

9. The flexible pipe for an exhaust pipe as defined by claim 6,
wherein a shock-absorbing member is attached to at least one of the elastic ring and the elastic ring holder portion.

10. The flexible pipe for an exhaust pipe as defined by claim 6, wherein the elastic ring is wound at least one turn around the outer periphery of the bellows portion.

11. The flexible pipe for an exhaust pipe as defined by claim 6, wherein the elastic ring is formed by connecting two ends of a flexible wire with a crimping member.
